(19) United States
(12) Patent Application Publication
(10) Pub. No.: US 2023/0158874 A1
(43) Pub. Date: May 25, 2023

(54) DOOR SYSTEM FOR A VEHICLE

(71) Applicant: Volvo Car Corporation, Goteborg (SE)

(72) Inventor: Andreas Lorentsson, Goteborg (SE)

(21) Appl. No.: 17/975,657

(22) Filed: Oct. 28, 2022

(30) Foreign Application Priority Data
Nov. 19, 2021 (EP) 21 209 328.0

(51) Int. Cl. B60J 10/84; B60J 5/04; B60J 10/30

(52) U.S. Cl. CPC B60J 10/85; B60J 5/0463; B60J 10/30

(57) ABSTRACT

A door system for a vehicle, including a door assembly and lateral roof assembly. The door assembly includes a door frame body, at least a first sealing member and a glazing element. The lateral roof assembly includes a lateral roof portion and at least a second sealing member. The door frame body surrounds at least partially the glazing element. The door frame body is movable between an open and closed position relative to the lateral roof assembly. The glazing element is adjustable between an open and closed position. The first sealing member is arranged between the glazing element and door frame body and seals the glazing element in the closed position of the glazing element. The second sealing member is arranged at the lateral roof portion and receives at least one edge of the glazing element in the closed position of the glazing element and door frame body.

### CROSS-REFERENCE TO RELATED APPLICATION

The present disclosure claims the benefit of priority of co-pending European Patent Application No. 21 209 328.0, filed on Nov. 19, 2021, and entitled “A DOOR SYSTEM FOR A VEHICLE,” the contents of which are incorporated in full by reference herein.

### TECHNICAL FIELD

The present disclosure relates to a door system for a vehicle, a vehicle including such a door system and a method for manufacturing such a door system.

### BACKGROUND

In a vehicle, a door generally includes a door frame with a window opening and a glass window, which may be raised to close the window opening and lowered to open the window opening. When the glass window is lowered into the open position, the window may be received in a cavity positioned inside the door frame between an outer door panel and an inner door panel. On the other hand, when the glass window is raised into the closed position, peripheral edges of the window may be received in U-shaped glass runs contacting an interior and/or an exterior surfaces of the glass window.

The door, at which the window glass is mounted, may include a frame surrounding the edges of the window glass when the window glass is fully raised, or a frameless door, at which the edges of the window glass are at least partially exposed without any frame.

### SUMMARY

Such door assemblies may be further improved, which provides a tight and safe arrangement of a window glass in a vehicle.

The problem is at least partially solved or alleviated by the subject matter of the present disclosure. It should be noted that the aspects of the disclosure described in the following apply to the door system for a vehicle, the vehicle including such a door system and the method for manufacturing such a door system.

According to the present disclosure, a door system for a vehicle is presented. The door system includes a door assembly and a lateral roof assembly. The door assembly includes a door frame body, at least a first sealing member and a glazing element. The lateral roof assembly includes a lateral roof portion and at least a second sealing member. The door frame body surrounds at least partially the glazing element. The door frame body is movable between an open position and a closed position relative to the lateral roof assembly. The glazing element is adjustable between an open position and a closed position. The first sealing member is arranged between the glazing element and the door frame body and configured to seal the glazing element in the closed position of the glazing element. The second sealing member is arranged at the lateral roof portion and configured to receive at least one edge of the glazing element in the closed position of the glazing element and the door frame body.

Compared to framed door systems, the door system of the present disclosure can optimize a height of an entire door bow section, accordingly driver's sight and a roof height. Further, compared to framed door systems, the door system may allow a flush arrangement of the glazing element, preferably with a b-pillar cover, which can be mounted at a vehicle body. In such a case, a monitoring range of sensors, which may be arranged at a lateral side of the vehicle to monitor its environment, may not be interfered by any protruding components. Further, compared to frameless door systems, the door system may improve Noise Vibration Harshness (NVH) of the vehicle when the door is in the closed position.

The door assembly may be pivotably mounted on the vehicle body. The door frame body may form a skeleton of the door assembly, thus, the door frame body may be pivotably connected to the vehicle body as well. The door frame body may be understood as a basic structure of a vehicle door, at which further components such as door cover, interior/exterior door handle, door hinge, seat adjustment means, sealing elements, door lock, audio system, window operating system, etc. may be arranged.

The door frame body may include a window opening, at which the glazing element, in other words a window glass, may be disposed and adjusted between the open position and the closed position. The glazing element may be retracted into the door frame body to open the window opening or advanced towards the window opening to at least partially or entirely close the window opening. In other words, the door frame body may at least partially encompass the glazing element. Still in other words, the door frame body may define an adjustment area of the glazing element.

The first sealing member may be arranged between the door frame body and the glazing element. The first sealing member may be configured to hold the glazing element in the closed position to prevent the glazing element from falling inwardly to the vehicle cabin and to maintain its position.

The lateral roof portion may be a part of the vehicle body. The term lateral roof portion may be understood as an uppermost portion of the vehicle and/or the vehicle body, which may extend from a front windshield to a rear windshield at the lateral side of the vehicle parallel to a driving direction. Thus, the second sealing member may be mounted at the vehicle body via the lateral roof portion, which may be positioned adjacent to the uppermost portion of the door assembly or the door frame body, in the closed position of the door frame body.

The second sealing member may be configured to receive an upper portion of the glazing element, if the glazing element is adjusted into the closed position and the door frame body is in the closed position. In other words, if both of the glazing element and the door frame body are in the closed position, an edge of the glazing element, preferably an upper edge facing the lateral roof portion of the vehicle may be surrounded by the second sealing member. The upper edge of the glazing element may be formed substantially horizontally and parallel to an extension direction of the lateral roof portion.

Generally, the glazing element moves in a vertical direction to open or close the window opening. Hence, when the door assembly is mounted to the vehicle body, in the closed position of the door frame body and the glazing element, the upper edge of the glazing element may be arranged adjacent to the lateral roof portion of the vehicle, at which the second sealing member may be mounted. Consequently, the edge of the glazing element may be received by the second sealing member and held in position without falling primarily outwardly but also inwardly relative to a vehicle cabin. Thus, the second sealing member may ensure the glazing element to be held in position.

The first sealing member and/or the second sealing member may include thermoplastic vulcanizate (or thermoplastic elastomer) (TPV), polymer or copolymer such as polypropylene. The first sealing member may include a lip seal structure. The second sealing member may be substantially U-shaped to receive the glazing element. Additionally or alternatively, the second sealing member may include at least one lip seal structure. The first sealing member and/or the second sealing member may be dimensioned for providing a tight seal between the vehicle body and the door frame body against noise and humidity, thus more comfort in the vehicle cabin.

In an example, the lateral roof assembly further includes a roof trim member. The roof trim member is arranged at the lateral roof portion. The roof trim member receives at least partially the second sealing member. The roof trim member may be dimensioned to extend at least partially along the lateral roof portion of the vehicle. The roof trim member may include a cantrail trim, which may extend substantially in a horizontal direction at least partially from the front windshield to the rear windshield at each lateral side of the vehicle.

The roof trim member may at least partially cover the second sealing member, particularly at an outside of the vehicle. Preferably, the second sealing member may be fixedly attached to the lateral roof portion via the roof trim member. Alternatively, each of the second sealing member and the roof trim member may be separately mounted at the lateral roof portion of the vehicle or the roof trim member may be fixedly attached to the lateral roof portion via the second sealing member.

In an example, the lateral roof assembly further includes a fixing means configured to fix the roof trim member at the lateral roof portion. The fixing means may include a mechanical means such as screw, rivet or clamp or an adhesive means. The roof trim member may be required to be fixedly and safely mounted at the lateral roof portion of the vehicle. Accordingly, the roof trim member may be coupled with at least one fixing means to be fixedly attached at the lateral roof portion of the vehicle. Alternatively or additionally, the roof trim member may be fixed to the lateral roof portion by a force-fitting manner or a form-fitting manner.

In an example, the second sealing member is inserted in the roof trim member by means of press fit, interference fit or snap fit. The second sealing member may be fixedly held by the roof trim member to be arranged at the lateral roof portion of the vehicle. The second sealing member may be inserted by a force-fitting manner such as press fit or interference fit or a form-fitting manner such as snap fit to be fastened in the roof trim member.

In an example, the door assembly further includes a third sealing member. The third sealing member is arranged at the door frame body and configured to seal between the door frame body and the lateral roof portion in the closed position of the door frame body. The third sealing member may include the same material as the first and/or the second sealing member. The third sealing member may include a tubular shape and/or lip seal structure. The third sealing member may be arranged between the vehicle body and the door frame body. The third sealing member may be attached to the door frame body facing the vehicle body, i.e. the lateral roof portion.

The third sealing member may be mounted at an uppermost portion of the door frame body facing the lateral roof portion of the vehicle. In the closed position of the door frame body, the third sealing member may be interposed between the vehicle body, i.e. lateral roof portion, and the door frame body. Hence, a direct contact between the door frame body and the vehicle body, both of which may include a metal material having a relative high strength, may be avoided. In addition, the third sealing member may be dimensioned for providing a tight seal between the vehicle body and the door frame body against noise and humidity, thus more comfort in the vehicle cabin. Further, the third sealing member may absorb an impact transferred from outside through the door frame body.

In an example, the lateral roof assembly further includes a fourth sealing member. The fourth sealing member is arranged at the lateral roof portion and configured to seal between the door frame body and the lateral roof portion in the closed position of the door frame body. In addition to the third sealing member, the fourth sealing member may be arranged between the vehicle body and the door frame body. The fourth sealing member may include the same material and shape as the third sealing member. The third sealing member and the fourth sealing member may be positioned next to or apart from each other along a cavity between the lateral roof portion of the vehicle and the door frame body. Accordingly, a tight seal against noise and humidity may be provided between the door frame body and the lateral roof portion in the closed position of the door frame body. Further, the third sealing member may absorb an impact transferred from outside through the door frame body.

Alternatively, the third sealing member may be connected to the vehicle body, i.e. lateral roof portion of the vehicle and the fourth sealing member may be connected to the door frame body. Further, both of the third sealing member and the fourth sealing member may be also connected to the door frame body or the lateral roof portion of the vehicle.

In an example, the third sealing member and the fourth sealing member are arranged substantially perpendicular to each other in the closed position of the door frame body. Since the door frame body may include a cavity to receive the glazing element when opening or auxiliary components, the door frame body may have a certain width. The third sealing member and the fourth sealing member may be arranged at least partially along a circumferential direction of the door frame facing the lateral roof portion of the vehicle to reliably seal between the door frame body and the lateral roof portion in the closed position of the door frame body.

For instance, the third sealing member may seal between the door frame body and the lateral roof portion parallel to a closing direction of the glazing element. Further, the fourth sealing member may seal between the door frame body and the lateral roof portion perpendicular to the closing direction of the glazing element. In other words, between the door frame body and the lateral roof portion of the vehicle a pair of the elastic element may be arranged perpendicularly to each other to damp any impact, noise, humidity or the like transmitted from outside in direction to the cabin of the vehicle.

In an example, the edge of the glazing element to be received by the first sealing member in the closed position of the glazing element and in the closed position of the door frame body is an upper horizontal edge of the glazing element. If both of the glazing element and the door frame body are in the closed position, an edge of the glazing element, preferably the upper edge facing the lateral roof portion of the vehicle may be surrounded by the second sealing member.

In an example, the door assembly further includes at least one run seal member. The run seal member is arranged at the door frame body and configured to receive at least one vertical edge of the glazing element. The run seal member may include substantially a U-shape and receive at least one, preferably both of the lateral, i.e. vertical edges of the glazing element. Together with the second sealing member, the run seal member may entirely encompass the glazing element, if the glazing element is raised into the closed positon and the door frame body is also in the closed position. Accordingly, the glazing element may be reliably sealed.

Each run seal member may be integrally formed with the first sealing member. Accordingly, the run seal member may hold the glazing element in position together with the first sealing member, particularly in the closed position of the glazing element to prevent the glazing element from falling inwardly to the vehicle cabin.

In an example, the first sealing member, the second sealing member, the third sealing member and/or the fourth sealing member include a tubular seal element and/or a lip seal element. However, the shape of each sealing member may not limited to those seal elements. The first sealing member, the second sealing member, the third sealing member and/or the fourth sealing member may be mainly configured to hold the door system and its components in position, particularly in its closed position. They may be also configured to provide a tight seal between the vehicle body, particularly the lateral roof portion and the door assembly against noise and humidity to provide more comfort in the vehicle cabin.

In an example, the door assembly further includes a concealing element arranged to cover the door frame body. The concealing element may include a material such as plastic, which may be light and easily processed in order to adapt it to a shape to be assembled to the door frame body. The concealing element may be configured to retain the door frame body and/or sealing members and hide them from the outside of the door assembly.

According to the present disclosure, a vehicle is presented. The vehicle includes a door system as described above. A vehicle body of the vehicle may include a lateral roof portion extending from a front windshield to a rear windshield. The lateral roof portion may face an upper portion of a door assembly when the door assembly, i.e. a door frame body and/or a glazing element, is in a closed position. Accordingly, a tight seal between the vehicle body and the door assembly may be ensured.

In an example, the vehicle includes at least two door assemblies, wherein the first door assembly is a front door assembly and the second door assembly is a rear door assembly. A first glazing element of the first door assembly and a second glazing element of the second door assembly are arranged flush with each other in case of a closed position of the door assemblies and glazing elements. The flush arrangement of the glazing elements may avoid aerodynamic drag, especially at high vehicle speeds, limiting the vehicle's fuel efficiency and speed. tightness the front door and/or rear door may be improved.

Preferably, the vehicle body may include two lateral roof portions, which are arranged parallel to each other. Hence, the door assembly may be arranged symmetrically at both lateral sides of the vehicle.

In an example, between the first glazing element and the second glazing element cover member may be arranged, which may be configured to cover a b-pillar of the vehicle. In other words, between the first door assembly/first glazing element and the second door assembly/second glazing element the b-pillar of the vehicle may be positioned. The vehicle may include several sensors at its lateral side for monitoring environment, thus, assisting autonomous driving functions of the vehicle. Such sensors may be preferably located at the b-pillar. The cover member may be configured to house such sensors.

The first glazing element, the second glazing element and the cover member may be arranged flush or non-flush relative to each other. In case of a flush arrangement, a monitoring range of sensors, which may be arranged at a lateral side of the vehicle to monitor its environment, may not be interfered by any protruding components. Preferably, such door assembly may be arranged at both lateral side of the vehicle relative to a driving direction.

According to the present disclosure, a method for manufacturing a door assembly for a vehicle is presented. The method includes:
providing a door assembly including a door frame body, at least a first sealing member and a glazing element,
providing a lateral roof assembly including a lateral roof portion and at least a second sealing member,
at least partially surrounding the glazing element by the door frame body,
arranging the first sealing member between the glazing element and the door frame body, and
arranging the second sealing member at the lateral roof portion.

The door frame body is movable between an open position and a closed position relative to the lateral roof assembly. The glazing element is adjustable between an open position and a closed position. The first sealing member is configured to seal the glazing element in the closed position of the glazing element. The second sealing member is configured to receive at least one edge of the glazing element in the closed position of the glazing element and the door frame body.

It should be noted that the above examples may be combined with each other irrespective of the aspect involved. Accordingly, the method may be combined with structural features and, likewise, the system may be combined with features described above with regard to the method.

These and other aspects of the present examples will become apparent from and elucidated with reference to the examples described hereinafter.

### BRIEF DESCRIPTION OF THE DRAWINGS

Exemplary aspects will be described in the following with reference to the following drawings.

FIG. 1 shows schematically and exemplarily an exampleof a vehicle including according to the present disclosure.

FIG. 2 shows schematically and exemplarily an exampleof a door system according to the present disclosure.

### DETAILED DESCRIPTION

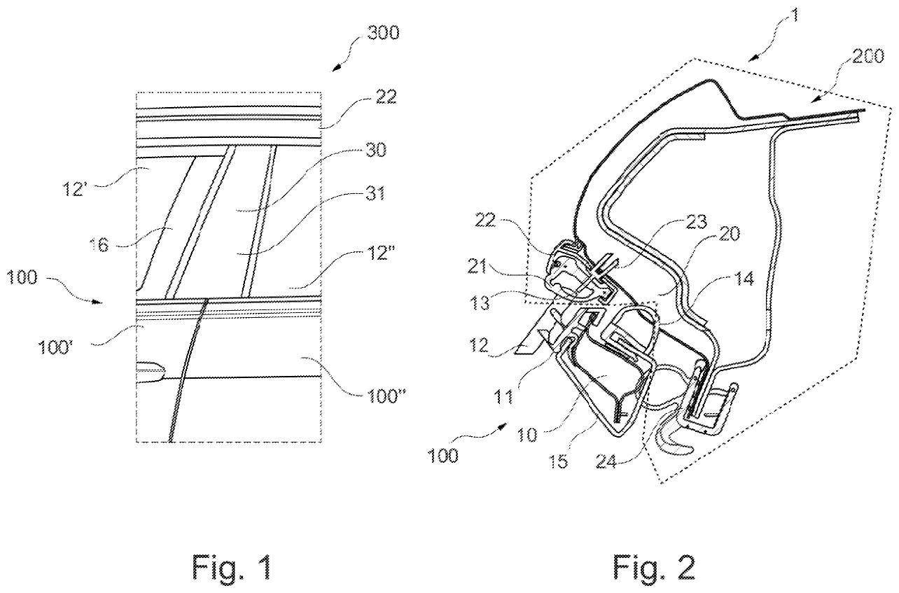

FIG. 1 shows a vehicle 300 including a door system 1. The door system 1 includes a door assembly 100 and a lateral roof assembly 200 (see also FIG. 2). The door assembly 100 may be a first (front) door assembly 100′ and/or a second (rear) door assembly 100″.

A vehicle body of the vehicle 300 includes at least one b-pillar 30 arranged between a first glazing element 12′ of the first door assembly 100′ and a second glazing element 12″ of the second door assembly 100″. The vehicle 300 may include several sensors at its lateral side for monitoring environment, thus, assisting autonomous driving functions of the vehicle 300. Such sensors may be preferably located at the b-pillar 30. A cover member 31 may be configured to house such sensors. The first glazing element 12′, the second glazing element 12″ and the cover member 31 of the b-pillar 30 may be arranged flush or non-flush relative to each other. In case of a flush arrangement, a monitoring range of sensors may not be interfered by any protruding components.

As shown in FIG. 2, the door assembly 100 includes a door frame body 10 and a glazing element 12. The door frame body 10 may be pivotably connected to the vehicle body of the vehicle 300. The door frame body 10 is, thus, movable between an open position and a closed position relative to the vehicle 300. The door frame body 10 surrounds at least partially the glazing element 12. The door frame body 10 includes a window opening, at which the glazing element 12 may be adjusted between an open position and a closed position.

The lateral roof assembly 200 includes a lateral roof portion 20 and a roof trim member 22. The lateral roof portion 20 may be the uppermost portion of the vehicle 300 and/or the vehicle body, which extends from a front windshield (now shown) to a rear windshield (now shown) at each lateral side of the vehicle 300 relative to a driving direction of the vehicle 300.

The roof trim member 22 is mounted at the lateral roof portion 20 via a fixing means 23. The fixing means 23 may include a mechanical means such as screw, rivet or clamp or an adhesive means. The roof trim member 22 is dimensioned to extend at least partially along the lateral roof portion 20 of the vehicle 300.

The door assembly 100 further includes a first sealing member 11 and the lateral roof assembly 200 further includes a second sealing member 21. The first sealing member 11 is arranged between the glazing element 12 and the door frame body 10 and configured to seal the glazing element 12 in the closed position of the glazing element 12. The first sealing member 11 is particularly formed to prevent the glazing element 12 from falling inwardly to the vehicle cabin and maintain its position.

The second sealing member 21 is configured to receive at least one edge of the glazing element 12 in the closed position of the glazing element 12 and the door frame body 10. The second sealing member 21 is mounted at the lateral roof portion 20 of the vehicle 300 via the roof trim member 22. The roof trim member 22 receives at least partially the second sealing member 21. In other words, the second sealing member 21 is inserted in the roof trim member 22 by means of press fit, interference fit or snap-in fit. Alternatively, the second sealing member 21 may be directly mounted at the lateral roof portion 20 without the roof trim member 22.

If the glazing element 12 is raised into the closed position and the door assembly 100 is also in the closed position, an edge of the glazing element 12, preferably an upper edge 13 facing the lateral roof portion 20 is surrounded by the second sealing member 21, which is directly mounted at the lateral roof portion 20 together with the roof trim member 22. Therefore, substantially no gap is visible between the lateral roof portion 20 and the door assembly 100 from outside of the vehicle 300.

The door assembly 100 further includes a third sealing member 14 and the lateral roof assembly 200 further includes a fourth sealing member 24. The third sealing member 14 is connected to the door frame body 10 to seal between the door frame body 10 and the lateral roof portion 20 of the vehicle 300 in the closed position of the door frame body 10. The fourth sealing member 24 is arranged at the lateral roof portion 20 and configured to seal between the door frame body 10 and the lateral roof portion 20 in the closed position of the door frame body 10.

In the closed position of the door frame body 10, both of the third sealing member 14 and the fourth sealing member 24 are interposed between the vehicle body, i.e. lateral roof portion 20, and the door frame body 10. Preferably, the third sealing member 14 and the fourth sealing member 24 are arranged along a circumference of the door frame body 10 and/or the lateral roof portion 20. Hence, a direct contact between the door frame body 10 and the vehicle body, both of which may include a metal material having a relative high strength, may be avoided.

The first sealing member 11, the second sealing member 21, the third sealing member 14 and/or the fourth sealing member 24 may include thermoplastic vulcanizate (or thermoplastic elastomer) (TPV), polymer or copolymer such as polypropylene. The first sealing member 11 includes a lip seal structure. The second sealing member 21 is substantially U-shaped to receive the upper edge 13 of the glazing element 12. The third sealing member 14 and/or the fourth sealing member 24 include a tubular seal element. However, the shape of each sealing member is not limited to the mentioned formed. Hence, the first sealing member 11, the second sealing member 21, third sealing member 14 and/or the fourth sealing member 24 include a tubular seal element and/or a lip seal element.

The first sealing member 11, the second sealing member 21, the third sealing member 14 and/or fourth sealing member 24 may be dimensioned such that it provides a tight seal between the vehicle body and the door frame body 10 against noise and humidity to provide more comfort in the vehicle cabin. Further, at least the third sealing member 14 and the fourth sealing member 24 are also configured to absorb an impact transferred from outside through the door frame body 10.

The door assembly 100 further includes a run seal member 16 (see FIG. 1). The run seal member 16 is arranged at the door frame body 10 and configured to receive at least one, preferably both vertical edges of the glazing element 12 in case of the closed position of the glazing element 12. Together with the second sealing member 21, the run seal member 16 may entirely encompass the glazing element 12, if the glazing element 12 is raised into the closed positon and the door frame body 10 is also in the closed position.

The door assembly 100 further includes a concealing element 15 arranged to cover the door frame body 10. The concealing element 15 is configured to retain the door frame body 10 and/or sealing members and hide them from the outside of the door assembly 100.

It has to be noted that embodiments of the disclosure are described with reference to aspects. In particular, some of the aspects of the disclosure are described with reference to method type claims whereas other aspects are described with reference to the device type claims. However, a person skilled in the art will gather from the above and the following description that, unless otherwise notified, in addition to any combination of features belonging to one type of subject matter also any combination between features relating to different aspects is considered to be disclosed with this application. However, all features can be combined providing synergetic effects that are more than the simple summation of the features.

While the disclosure has been illustrated and described in detail in the drawings and description, such illustration and description are to be considered illustrative or exemplary and not restrictive. The disclosure is not limited to the disclosed examples. Other variations to the disclosed examples can be understood and effected by those skilled in the art in practicing a claimed disclosure, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A door system for a vehicle, the door system comprising:
a door assembly; and
a lateral roof assembly;
the door assembly comprising a door frame body, at least a first sealing member and a glazing element;
the lateral roof assembly comprising a lateral roof portion and at least a second sealing member;
the door frame body surrounding at least partially the glazing element;
the door frame body being movable between an open position and a closed position relative to the lateral roof assembly;
the glazing element being adjustable between an open position and a closed position;
the first sealing member being arranged between the glazing element and the door frame body and configured to seal the glazing element in the closed position of the glazing element; and
the second sealing member being arranged at the lateral roof portion and configured to receive at least one edge of the glazing element in the closed position of the glazing element and the door frame body.

2. The door system according to claim 1, the lateral roof assembly further comprising a roof trim member, the roof trim member being arranged at the lateral roof portion, the roof trim member receiving at least partially the second sealing member.

3. The door system according to claim 2, the lateral roof assembly further comprising a fixing means, the fixing means being configured to fix the roof trim member at the lateral roof portion.

4. The door system according to claim 2, the second sealing member being inserted in the roof trim member by means of press fit, interference fit or snap-in fit.

5. The door system according to claim 1, the door assembly further comprising a third sealing member, the third sealing member being arranged at the door frame body and configured to seal between the door frame body and the lateral roof portion in the closed position of the door frame body.

6. The door system according to claim 5, the lateral roof assembly further comprising a fourth sealing member, the fourth sealing member being arranged at the lateral roof portion and configured to seal between the door frame body and the lateral roof portion in the closed position of the door frame body.

7. The door system according to claim 6, the third sealing member and the fourth sealing member being arranged substantially perpendicular to each other in the closed position of the door frame body.

8. The door system according to claim 1, the edge of the glazing element being received by the first sealing member in the closed position of the glazing element and in the closed position of the door frame body being an upper horizontal edge of the glazing element.

9. The door system according to claim 1, the door assembly further comprising at least one run seal member, the run seal member being arranged at the door frame body and configured to receive at least one vertical edge of the glazing element.

10. The door system according to claim 6, the first sealing member, the second sealing member, the third sealing member and/or fourth sealing member comprising a tubular seal element and/or a lip seal element.

11. The door system according to claim 1, the door assembly further comprising a concealing element, the concealing element being arranged to cover the door frame body.

12. A vehicle comprising the door system according to claim 1.

13. The vehicle according to claim 12, further comprising at least two door assemblies, the first door assembly being a front door assembly and the second door assembly being a rear door assembly, the first glazing element of the first door assembly and the second glazing element of the second door assembly being arranged flush with each other in case of a closed position of the door assemblies and glazing elements.

14. A method for manufacturing a door system, the method comprising:
providing a door assembly comprising a door frame body, at least a first sealing member and a glazing element;
providing a lateral roof assembly comprising a lateral roof portion and at least a second sealing member;
at least partially surrounding the glazing element by the door frame body;
arranging the first sealing member between the glazing element and the door frame body; and
arranging the second sealing member at the lateral roof portion;
the door frame body being movable between an open position and a closed position relative to the lateral roof assembly;
the glazing element being adjustable between an open position and a closed position;
the first sealing member being configured to seal the glazing element in the closed position of the glazing element; and
the second sealing member being configured to receive at least one edge of the glazing element in the closed position of the glazing element and the door frame body.
